(19) United States
(12) Patent Application Publication
(10) Pub. No.: US 2010/0115070 A1
(43) Pub. Date: May 6, 2010

(54) Method for generating manipulation requests of an initialization and administration database of server cluster, data medium and corresponding a server cluster, data medium and corresponding service cluster

(76) Inventor: Thierry Missimilly, Vaulnaveys le haut (FR)

Correspondence Address: Bull HN Information Systems Inc.;Attn: Russell W. Guenthner, 13430 N. Black Canyon Highway, Phoenix, AZ, 85029-1348, US

(21) Appl. No.: 12/454,977

(22) Filed: May 27, 2009

(30) Foreign Application Priority Data
May 27, 2008 (FR) 08 02861

(51) Int. Cl. G06F 17/30; G06F 15/177

(52) U.S. Cl. 709/222; 707/803; 707/E17.005

(57) ABSTRACT

This method relates to the generation of manipulation requests of an initialization and administration database of a server cluster comprising several nodes interconnected between each other by at least one data transmission network. It comprises steps of generating from a logical distribution of the nodes of the cluster, from a geographical distribution and from a hardware definition of the nodes of the cluster at least one set of profiles of the nodes and of the data transmission network; defining an addressing policy of the nodes of the cluster; allocating from the set of profiles and according to the addressing policy, at least one address to each node of the server cluster and generating a set of parameters of the cluster; and generating from the set of parameters of the cluster and of the addresses of its nodes, at least one file of manipulation requests of the database.

### CROSS REFERENCE TO RELATED APPLICATIONS

This application claims priority under 35 U.S.C. Section 119 to:
Application Number: 08 02861
Country: FR
Holder: Bull SAS
Title:
   “Procédé de generation de requêtes de manzulation d'une base de données d'initialisation et d'administration d'une grappe de serveurs, support de données et grappe de serveurs correspondants”
Filing date: May 27, 2008
Inventor: MISSIMILLY, Thierry
   and which is hereby incorporated by reference.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The present invention relates to a method for generating manipulation requests of an initialization and administration database of a server cluster comprising several nodes interconnected between each other by at least one data transmission network. It also relates to a data medium for the implementation of this method and a server cluster comprising a database completed by requests generated according to this method.

Server clusters are known notably comprising several calculation nodes interconnected with each other. The server clusters of this type are computer installations generally comprising several networked computers, appearing from the outside as a computer with very high computing power, known as a computer with high processing power or HPC computer (“High Performance Computing”). These optimized installations enable the distribution of complex processing operations and/or parallel computations on at least one part of the computation nodes.

Certain server clusters, among the most simple, can comprise homogeneous elements observing a same identification protocol, such that these elements can be identified automatically when the installation is powered up, for a correct initialization and administration of the cluster. This is unfortunately not the case with most of the complex server clusters existing today, with very high computation capacities, for which the generation of a database using all the heterogeneous elements and parameters of the server cluster is necessary. This database thus represents the unique reference of the configuration and of the status of the server cluster.

A major difficulty consists in providing this database with all the information necessary for the initialization and the administration of the server cluster, using requests. The minimum information required is static data of the logical and hardware description of the elements of the server cluster and of their interrelationships such as for example a description of the hardware, a geographical location of the servers and nodes of the cluster in a computation center, a status of the software tools installed, operating data of the cluster, or a status of the hardware.

To provide the information of the database, often defined in the form of a relational database, manipulation requests of the database are generally defined. To fill in a server cluster database, they are written manually in the form of line codes contained in one or more files, being able to reach several thousands of lines for the complex server clusters. To inspect the technical documents defining a server cluster, including the architecture and the wiring of the cluster, and writing these manipulation requests of the database can take several months. Furthermore, the writing is not generally structured according to a pre-established order, which makes it even more difficult and long. Finally, the manual writing of the manipulation requests is a source of entry errors and requires many consistency checks.

### BRIEF SUMMARY OF THE INVENTION

It is noted that certain elements of the present invention could be implemented as either hardware, software or firmware components, and that any description of any specific implementation provided herein does not imply that a specific or limiting approach is implied. The description is exemplary in describing one or more illustrated embodiments, and alternatives could be determined or designed by one skilled in the art.

Thus, the present invention is directed to providing a generation method of manipulation requests of an initialization and administration database of a server cluster that enables the aforementioned problems and constraints to be overcome.

The present invention is therefore is directed to a method for generating manipulation requests of an initialization and administration database of a server cluster comprising several nodes interconnected between each other by at least one data transmission network, wherein the method comprises the following steps:
generation of at least one set of profiles of the nodes and of the data transmission network, from a logical distribution of the nodes of the cluster in the data transmission network, a geographical distribution and a hardware definition of the nodes of the cluster,
definition of an addressing policy of the nodes of the cluster,
allocation of at least one address to each node of the server cluster and generation of a set of parameters of the cluster from the set of profiles and according to the addressing policy, and
generation of at least one file of manipulation requests of the initialization and administration database of the server cluster from the set of parameters of the cluster and of the addresses of its nodes.

Hence, the invention takes advantage of the definition of an addressing policy of the nodes of the server cluster to structure in an original manner the generation steps of a set of parameters of the cluster that, after application of the addressing policy to the node addresses of the server cluster, enables a facilitated, even automated, generation of a file of manipulation requests of the database to be considered.

Optionally, the generation step of at least one set of profiles of the nodes and of the data transmission network comprises the generation of a summary digital file from a first predetermined digital file of a logical representation of the server cluster and a second predetermined digital file of a physical representation of the server cluster.

Also optionally, the definition step of an addressing policy comprises the definition of software rules for allocating available IP addresses to at least one part of the elements constituting the server cluster, and the allocation step of at least one address to each node of the server cluster is carried out by the execution of these software rules.

Also optionally, the software rules comprise at least one of the elements of the set constituted by the following software rules:
choice of an IP addressing class according to the number of IP addresses to distribute in the server cluster,
a priori reservation of some addresses for switches of the data transmission network,
a priori reservation of some addresses as virtual addresses of nodes,
a priori reservation of an address zone, for nodes interconnected in series, in which a first address is reserved for a serial interface between the nodes interconnected in series and the rest of the server cluster and the following ones for each of the nodes interconnected in series,
automatic allocation of an address, or an address interval, to a node of the cluster according to its identifier in the cluster by means of a predefined formula,
allocation of an IP address to each data transmission network of the server cluster.

Also optionally, a method according to the invention comprises a step during which the request file is executed in such a manner as to complete the database of the server cluster.

The invention also is directed to a downloadable computer program product from a communication network and/or recorded on a medium readable by computer and/or executable by a processor, wherein the program product comprises program code instructions for the implementation of steps of a method of generating manipulation requests of an initialization and administration database of a server cluster as defined previously.

The invention is also directed to a server cluster comprising several nodes interconnected between each other by at least one data transmission network, including at least one administration server of the nodes of the cluster associated with an administration data storage rack, wherein the server cluster further comprises an initialization and administration database completed by requests generated by a method such as defined previously, the initialization and administration data being stored in the administration data storage rack and the administration server comprising means for managing this database.

Optionally, at least one part of the nodes comprises computation nodes and the data transmission network comprises at least one interconnection network of the computation nodes.

Also optionally, the server cluster further comprises at least one traffic management node and at least one data backup node, and the data transmission network further comprises at least one administration network different from the interconnection network of the computation nodes for the connection of the administration server to the computation, traffic management and data backup nodes.

### BRIEF DESCRIPTION OF THE SEVERAL VIEWS OF THE DRAWING

The invention will be better understood by means of the following description, given only as an example and in reference to the following drawings, wherein:

FIG. 1 diagrammatically shows the general structure of an example of server clusters of the HPC computer type,

FIG. 2 diagrammatically shows the configuration of a database for carrying out the management of the server cluster of FIG. 1,

FIG. 3 illustrates the successive steps of a method for generating and providing the information of the database of FIG. 2, according to the teachings of the present invention.

### DETAILED DESCRIPTION OF THE INVENTION

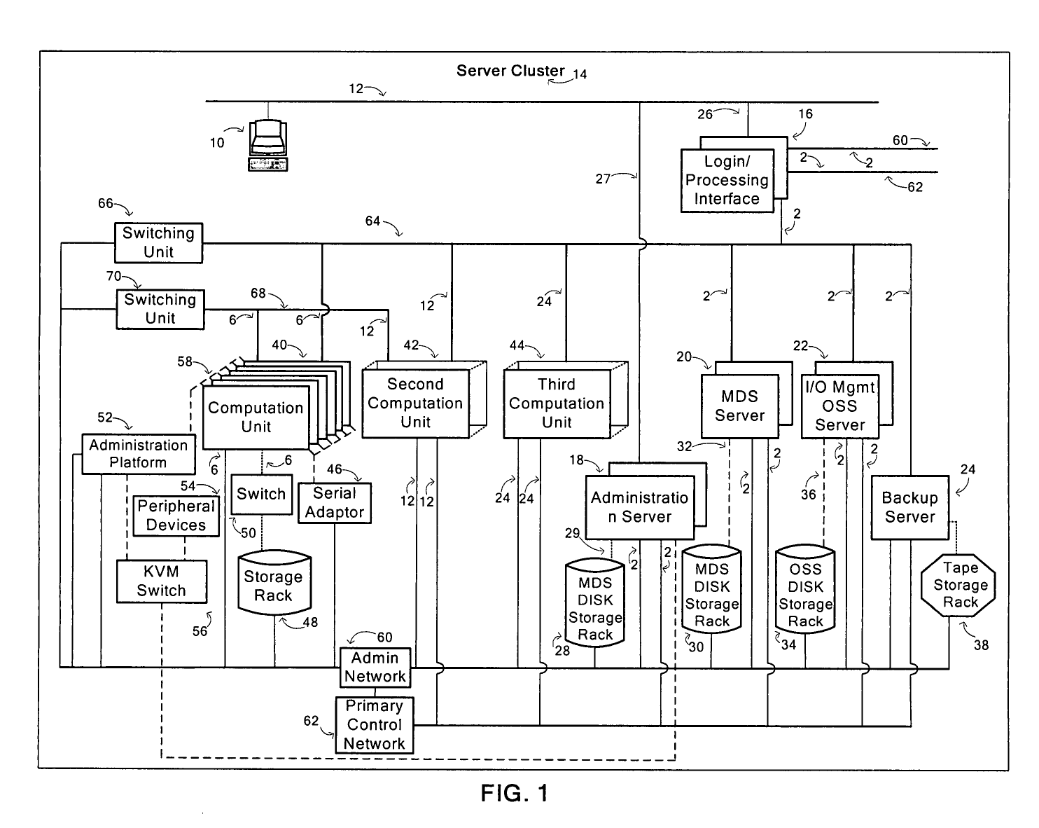

The computer installation in FIG. 1 comprises a command terminal 10 connected to a backbone network 12. It is also to this backbone network 12 that a server cluster 14 appearing from the exterior, that is from the viewpoint of the command terminal 10, is connected, as a single HPC computer entity.

The server cluster 14 comprises several computers interconnected between each other by means of several networks, these other computers being heterogeneous.

All of the computers of the server cluster 14 constitute nodes of this cluster. In a more general manner, a node is a computer being able to comprise one or more computation unit(s).

In the server cluster 14, two types of nodes can be distinguished: the computation nodes and the service nodes. The computation nodes are those nodes that effectively execute the different processing instructions commanded from the command terminal 10, under the supervision of the service nodes.

Most of the service nodes are duplicated for reasons of reliability. In other words, each service node may be associated with a replica or duplicate node comprising the same (or very closely the same) characteristics as it and ready to replace it immediately in the event of failure.

It will be noted moreover that in FIG. 1, each time that a multiplicity of links exists between two entities (nodes and/or network portions), only one link will be shown and which is accompanied by a number indicating the number of links existing between the two entities, for the sake of the clarity of this Figure. Indeed, if each link had to be shown, due to the complexity of the server cluster 14, this would give rise to confusion that would be detrimental to the understanding of the invention.

All the service nodes of the server cluster 14 of FIG. 1 comprise a processing interface 16, an administration server 18, a metadata management server (MDS) 20 of the cluster, an inputs/outputs management server 22 and a backup server 24.

The processing interface 16, more commonly qualified as Login interface, fulfils a computation interface function between the backbone network 12 and the server cluster 14. It is a priori of the same type as the computation nodes but is further equipped with compilers and specific computation tools the presence of which may be necessary to process the instructions received from the command terminal 10. The processing interface 16 may be duplicated, as indicated previously for reasons of reliability, and is therefore connected, with its replica/duplicate, to the backbone network 12 by means of two links 26.

The administration server 18 fulfils a general administration function of the server cluster 14. It is notable that this server manages the distribution of the instructions transmitted by the processing interface 16 to the different computation nodes according to their type and availability. It (the administration server) may also be duplicated for reasons of reliability. The administration server 18 and its replica or duplicate share a disk storage rack 28 to which they are connected by a plurality of optical fibers or links 29, for very rapid access to the stored data.

To enable the administration of the server cluster 14 by a user of the command terminal 10, the administration server 18 is also generally connected directly to the backbone network 12 with its replica by means of two links 27. This further enables a user of the command terminal 10 to have greater control over the strategies and computation options chosen by the server cluster 14. Moreover, in certain embodiments of server clusters of small dimensions not having a Login interface, this double link 27 is the sole link between the server cluster and the backbone network.

The metadata management server 20, otherwise known as MDS server (“Meta Data Server”) and the inputs/outputs management server 22, otherwise known as OSS server (“Object Storage Server”) fulfill a management function of the traffic of the data processed by the computation nodes of the server cluster 14. The management system may include a management system of distributed files, for example the Lustre system (registered trademark).

These two servers are also duplicated and are each connected to a storage rack by optical fibers (optical links). The MDS server 20 and its replica share a disk storage rack 30 to which they are connected by a plurality of optical fibers (links) 32. Likewise, the OSS server 22 and its replica share a disk storage rack 34 to which they are connected by a plurality of optical fibers 36.

Finally the backup server 24 manages the protection of the data of the entire HPC computer and for this purpose is connected to a tape storage rack 38. This backup server 24, in contrast to the other service nodes of the server cluster 14, is not duplicated in the example illustrated in FIG. 1.

For exemplary purposes the computation nodes of the HPC computer of FIG. 1 are heterogeneous and comprise several units of computation nodes such as for example a first computation unit 40 comprising six servers, a second computation unit 42 comprising twelve servers and a third computation unit 44 comprising twenty-four servers.

The first computation unit 40 comprises six fast computation servers connected in a serial network and further connected to a serial adaptor 46 realizing a translation of the serial ports of each of the servers of this first unit 40 into IP addresses (“Internet Protocol”) identifiable by an Ethernet type network. The serial adaptor 46 more generally fulfills an interface function between the serial network of the first computation unit 40 and the administration network of the server cluster 14.

Moreover, the six servers of the first computation unit 40, in this example, share a specific storage rack 48 to which they are connected via a switch 50. This storage rack 48 gives access to volumes of data that are for example organized according to their own file management system, that can be different from the one managed by the MDS 20 and OSS 22 servers.

A specific administration of this first computation unit 40 is provided by an administration platform 52 associated with peripheral devices 54 such as a screen and/or keyboard and/or mouse. The administration platform 52 is in practice a computer dedicated to the monitoring of the six fast computation servers. Hence, the first computation unit 40, as represented in the FIG. 1, may be designed to be more powerful than the second and third computation units 42 and 44.

The peripheral devices 54 can be shared between the administration platform 52 and the administration server 18 of the HPC computer by means of a KVM switch 56 (“Keyboard Video Mouse”), thus enabling an operator to act directly on the site of the server cluster 14 for carrying out an operation on the administration platform 52 and/or the administration server 18.

The different nodes of the aforementioned server cluster 14 are interconnected between each other by means of several networks.

It has already been seen that a first network 58, called serial network, specifically connects the fast computation servers of the first computation unit 40 to each other.

A second network 60, called administration network, generally of the Ethernet type, enables the administration server 18 of the server cluster 14 to be connected, via an administration port of this server, to the other nodes of the cluster such as the processing interface 16, the MDS server 20, its replica and its storage rack 30, the OSS server 22, its replica and its storage rack 34, the backup server 24 and its tape storage rack 38, the first, second and third computation units 40, 42 and 44, the specific storage rack 48 of the first computation unit 40, the serial adaptor 46 and the administration platform 52.

Optionally, according to the hardware used for the server type nodes of the computer, the second administration network 60 can be duplicated by a primary control network 62 connected to the administration server 18 via a primary control port of this server different from the administration port. This primary control network 62 is dedicated to the powering up, the starting, the shutting down and the processing of certain predetermined primary errors, called fatal errors and generating Core files, of the servers that it administers. In the example of FIG. 1, the primary control network 62 connects the administration server 18 to the processing interface 16 and to its replica, to the MDS server 20 and to its replica, to the OSS server 22 and to its replica, to the backup server 24, and to the second and third computation units 42 and 44.

A third interconnection network 64, called interconnection network of the computation nodes, connects between them, on the one side, the servers of the first, second and third computation units 40, 42 and 44, and, on the other side, the processing interface 16, the MDS server 20, the OSS server 22 and the backup server 24. The switching of the data transiting between the different elements interconnected by this interconnection network 64 is provided by a switching unit 66 of this network that is itself connected to the administration network 60. This third interconnection network 64 has very high bandwidth characteristics in relation to the bandwidth characteristics of the administration network 60. It is indeed through this interconnection network 64 that the computation data necessary for the execution of the processing instructions transmitted by the command terminal 10, transits via the processing interface 16.

Optionally, the third interconnection network 64 can be doubled or duplicated by an additional interconnection network 68 connected to at least one part of the elements already connected between each other by the third interconnection network 64. For example, in the server cluster 14 of FIG. 1, the additional interconnection network 68 connects the servers of the first and second computation units 40 and 42 to double their bandwidth. Likewise, the switching of the data in transit between the different elements interconnected by this additional interconnection network 68 is provided by an additional switching unit 70 of this network that is itself connected to the administration network 60.

The structure of the server cluster 14, such as described previously in reference to the FIG. 1, is appropriate to implement the invention, but other possible cluster configurations, notably of the HPC computer type, comprising all or part of the aforementioned elements, even comprising other elements in the case of greater complexity, are also suitable. In a simple configuration, a server cluster comprises service nodes comprising at least one administration server, computation nodes, an administration network connecting the administration node to the other nodes of the cluster and an interconnection network of the computation nodes whose higher bitrate than the one of the administration network enables higher computation performances to be obtained.

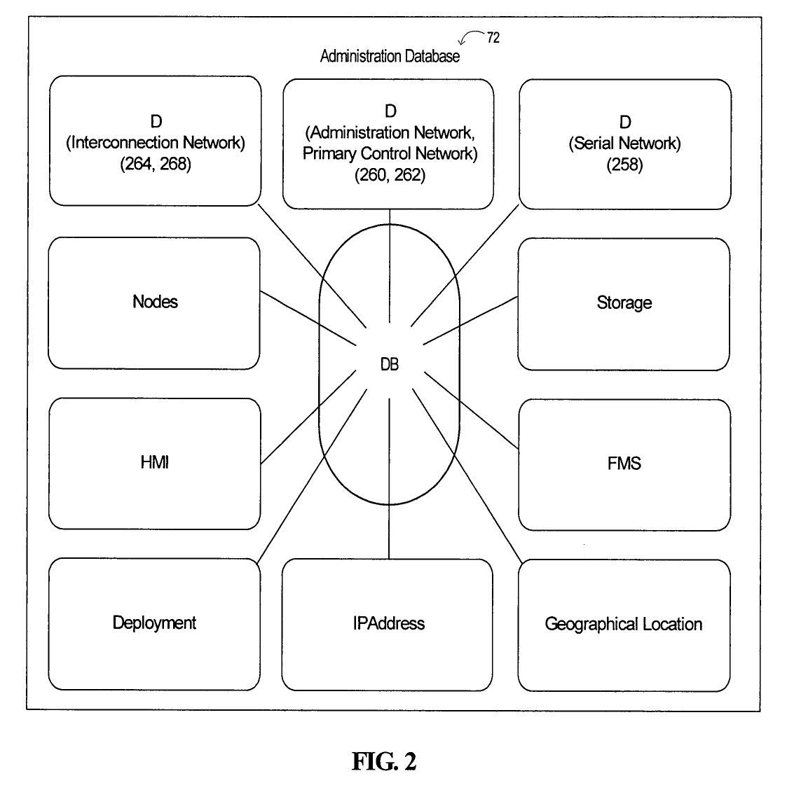

With reference to FIG. 2, such a server cluster 14, composed of various heterogeneous elements, requires an initialization and administration database 72, the administration tools of which are for example hosted by the administration server 18 and the description data of which are stored in the storage rack 28 associated with the administration server 18. The data, static or dynamic, of the administration database 72 is regularly backed up to the tape storage rack 38. This administration database 72 is diagrammatically represented in FIG. 2.

As shown, the database 72 comprises a database core DB, notably including its administration tools, and the structured description data (D(258), D(260,262), D(264,268), nodes, HMI, deployment, IP Address, geographical location, FMS, storage) aiming to provide the information necessary to initialize and administer the server cluster 14.

This information first of all comprises data D(258), D(260,262), D(264,268) relating to the different networks of the server cluster 14: the first serial network 58, the second administration network 60, 62 and the third interconnection network 64, 68. This data relates for example to the type of network, its transmission capacities, an identifier of the provider, etc.

The information further comprises “node” data on the server type nodes of the server cluster 14 such as the nodes connected to the primary control network 62: the type of each node, (computation, administration server, etc.), its technical characteristics (model, hardware status, computation capacity, RAM memory and status of the software tools installed), an identifier of the provider, etc.

The information also comprises “storage” description data relating to the storage infrastructure, on the logical division of volume, on the deployment models, etc.

It also comprises “HMI” (Human Machine Interface) information relating to the human machine interface used by the server cluster 14, “FMS” (File Management System) data relating to the file management system used (for example the Lustre system), “deployment” data relating to the organization of the deployment in the server cluster 14, “IPAddress” data relating to the distribution of IP addresses within the cluster, as well as the “geographical location” data relating to the geographic location of the different elements.

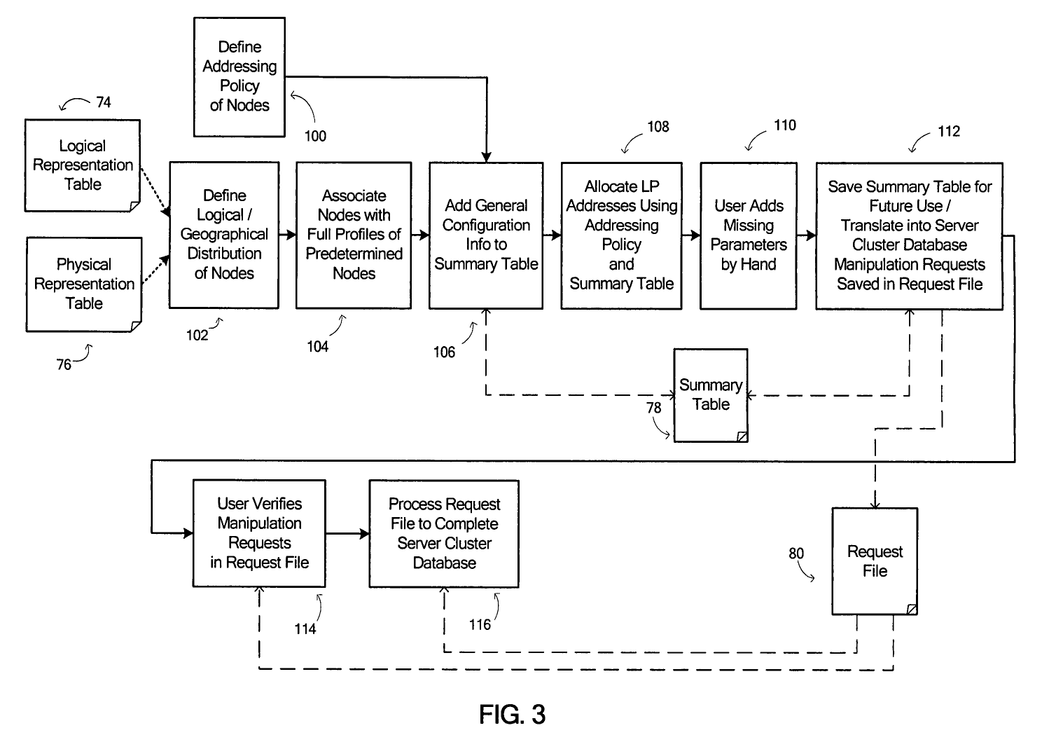

To generate the administration database 72, that is to provide the values of its description data, use is advantageously made of a method employing the teachings of the present invention such as the one for which the steps are illustrated in FIG. 3.

With reference to FIG. 3 during a prior step 100, an addressing policy of the nodes of the server cluster 14 is defined.

By taking the example of the version 4 of the IP protocol, an IP address of a node of the cluster is defined by four bytes the values of which are separated by periods, by ordering them from the byte having the greatest weight to the one with the least weight. Assuming that this address is of class C, the first three bytes define the server cluster as local network and the last byte theoretically enables 255 IP addresses to be distributed to the nodes of the server cluster. If the server cluster comprises too many nodes in relation to the addresses theoretically available in class C, then its IP address can be selected from class B.

An addressing policy consists in predefining logical rules for allocating available addresses. It comprises for example the following rules:
choice or selection of the addressing class according to the number of addresses to distribute in the server cluster,
a priori reservation of certain addresses for the switches of the administration network,
a priori reservation of certain addresses for the switches of the interconnection network of the computation nodes,
a priori reservation of certain addresses as virtual addresses of nodes thus identified by an alias when they are duplicated (this is notably the case for the processing interface 16, for the administration server 18 and for the traffic management nodes 20 and 22),
a priori reservation of an address zone, for the computation nodes interconnected in series such as the nodes of the first computation unit 40, zone in which the first address is reserved for the serial interface concerned, such that the serial adaptor 46, and the following for each of the computation nodes interconnected in series,
automatic allocation of an address, or an address interval, to a node of the cluster according to its identifier in the cluster by means of a predefined formula,
allocation of an IP address to each of the three networks of the server cluster 14,
etc.

A formula for the automatic allocation of addresses Ai to the nodes Ni of the cluster according to their identifier id(Ni) is for example:

Ai=aaa.bbb.ccc.[1+id(Ni)],

where aaa.bbb.ccc.0 is the general IP address of the server cluster 14 in class C.

During a generation start step 102 of the administration database 72, static data, defining a logical and geographical distribution of the nodes of the cluster in its different networks, and materially defining the nodes of the cluster, is gathered and verified by an operator.

In a classic manner this data is available in the form of digital files, for example tables of data generated by means of a spreadsheet program. Indeed, these documents generally come from a technical study phase following a request for proposals and aiming to define the specific architecture of the server cluster 14.

A first table 74, that will be called logical representation table of the server cluster 14, comprises a list of the hardware and port interconnections constituting the cluster accompanied by all the information enabling them to be identified in a unique manner as hardware and as elements of the cluster (notably this document allocates identifiers for each node of the cluster).

A second table 76, that will be called physical representation table of the server cluster 14, provides additional information on the elements of the server cluster, by specifying their location in a computation center intended to receive the server cluster, for example using a system of coordinates, notably by specifying for each cable the necessary length, by further indicating certain weight or location constraints, etc.

The verification by the operator consists in ensuring that the fields of the tables 74 and 76 necessary to the generation of the administration database 72 are provided with the correct information.

During this same step 102, a new file of type table 78, that will be called summary table, is created. In this summary table 78, a first tab is created using at least the information necessary to generate the administration database 72 from data extracted from the logical representation table 74. A second tab is created using at least the information necessary to generate the administration database 72 from data extracted from the physical representation table 76. Possibly, an additional summary tab is created using the list of the hardware composing the server cluster 14. This list can also be extracted from the logical representation table 74.

Next, during a generation step 104 of node profiles, on the basis of full profiles of predetermined nodes, each node of the server cluster 14 listed in the summary table 78 is associated, to the extent possible, with one of the predetermined profiles according to the information already contained on this node. This profile with which the node is associated is integrated into the summary table 78.

During a next step 106, general configuration information of the server cluster 14 is added to the data already recorded in the summary table 78. This information notably relates to:
a certain number of software systems used by the server cluster 14 for its general operation, among which the file management system, the resource manager system, the batch manager system, the data transmission security management system, and
a certain number of parameters indicating for example the existence of a virtual network, the duplication of certain nodes, etc.

It will be noted that this information can come from a pre-existing summary table similar to the summary table 78, created during a previous database generation for example.

Next, during a step 108 of IP address allocation, by means of the predetermined addressing policy (step 100) and data already contained in the summary table 78 on the different elements of the server cluster, IP addresses are automatically generated and allocated to the elements concerned. Notably, in accordance with the previously described addressing policy:
a choice or selection of addressing class is made according to the number of bytes necessary so that all the elements of the cluster concerned have an address,
virtual IP addresses are possibly defined,
IP addresses of virtual networks are defined according to the general configuration information, and
the available IP addresses are distributed between the nodes of the server cluster 14 according to the predefined formula.

During a step 110, if during the step 104 all the nodes of the server cluster 14 were unable to have been associated with predetermined profiles, or if new servers or storage racks with non-referenced profiles must be introduced, the missing parameters are completed for example by an operator in the summary table 78.

When the summary table 78 is complete, it is saved for a possible future use (see step 106) and its data is automatically translated into manipulation requests of the administration database 72 of the server cluster 14 that are saved to a request file 80, during a step 112.

This translation of data of a file of table type into requests is classic and will not be detailed herein.

During a step 114, an operator verifies the result of the translation of data into requests. At this stage, an interaction is possible to modify the request file 80.

Finally, during a last step 116, this request file 80 is executed by the administration server 18 on site, when the server cluster 14 is installed and in an operating state, in such a manner as to complete the administration database 72 of the cluster that can then be used to initialize and/or administer the server cluster 14.

It appears clearly that a method for generating databases such as previously described, for the initialization and administration of a cluster server, notably of the HPC computer type, noticeably improves the reliability of the data recorded and the speed of installation or initialization of such a cluster.

Moreover, it will be apparent to those skilled in the art that diverse modifications can be made to the embodiment described above, in the light of the above teachings. In the claims that follow, the terms used are not to be interpreted as limiting the claims to the illustrated embodiment, but are to be interpreted to include in it all that the claims aim to cover due to the fact of their formulation and whose prediction is within the scope or reach of those skilled in the art by applying their general knowledge to the implementation of the above described teaching.

Having now described the embodiments of the invention, it will become apparent to one of skill in the arts that other embodiments incorporating the concepts may be used. It is felt, therefore, that these embodiments should not be limited to the disclosed embodiments but rather should be limited only by the spirit and scope of the following claims.

What is claimed is:

1. A method for generating manipulation requests of an initialization and administration database of a server cluster comprising several nodes of the server cluster interconnected between each other by at least one data transmission network, the method comprising the following steps:
A) generating at least one set of profiles of the nodes and of the data transmission network from:
1) a logical distribution of the nodes of the server cluster in the data transmission network,
2) a geographical distribution, and,
3) a hardware definition of the nodes of the server cluster;
B) defining an addressing policy of the nodes of the server cluster;
C) allocating at least one node address to each of the several nodes of the server cluster and generating a set of parameters of the cluster derived from the set of profiles and according to the addressing policy of step B;
and,
D) generating at least one file of manipulation requests for application to the initialization and administration database of the server cluster based upon the set of parameters of the cluster and the node addresses of the plurality of the nodes of the server cluster.

2. The method for generating manipulation requests of the initialization and administration database of a server cluster according to claim 1, wherein, step A) of generating at least one set of profiles of the nodes and of the data transmission network further comprises the step of:
generating a summary digital file derived from:
a) a first predetermined digital file of logical representation of the server cluster, and,
b) a second predetermined digital file of physical representation of the server cluster.

3. The method for generating manipulation requests of the initialization and administration database of a server cluster according to claim 1, wherein, step B) of defining an addressing policy of the nodes of the server cluster further comprises:
defining software rules for allocating available IP addresses to at least one part of the elements comprising the server cluster;
and wherein:
step C) allocating of at least one node address to a plurality of the nodes of the server cluster is carried out by executing the software rules for allocating IP addresses of Step B).

4. The method for generating manipulation requests of an initialization and administration database of the server cluster according to claim 3, wherein the software rules for allocating IP addresses comprise at least one of the following operations:
A) selection of an IP addressing class according to a total number of IP addresses to distribute in the server cluster;
B) a priori reservation of some IP addresses for switches of the data transmission network;
C) a priori reservation of some IP addresses as virtual addresses of nodes,
D) a priori reservation of an address zone, for nodes of the server cluster interconnected in series, in which a first address is reserved for a serial interface between the nodes of the server cluster interconnected in series and the rest of the nodes of the server cluster, and the following addresses for each of the nodes interconnected in series;
E) automatic allocation of an IP address, or an IP address interval, to a node of the server cluster according to its identifier in the server cluster by means of a predefined formula; and,
F) allocation of an IP address to each data transmission network of the server cluster.

5. The method for generating manipulation requests of an initialization and administration database of a server cluster according to claim 1, further comprising a step of executing the file of manipulation requests so as to complete the administration database of the server cluster.

6. A computer program product readable by a computer to be used for generating manipulation requests in constructing an initialization and administration database of a server cluster comprising several nodes interconnected between each other by at least one data transmission network, the product comprising the following:
A) instructions for generating at least one set of profiles of the nodes and of the data transmission network from:
1) a logical distribution of the nodes of the server cluster in the data transmission network,
2) a geographical distribution, and,
3) a hardware definition of the nodes of the server cluster;
B) instructions defining an addressing policy of the nodes of the server cluster;
C) instructions allocating at least one node address to a plurality of the nodes of the server cluster and generation of a set of parameters of the cluster derived from the set of profiles and according to the addressing policy of step B;
and,
D) instructions generating at least one file of manipulation requests for application to the initialization and administration database of the server cluster based upon at least the set of parameters of the cluster and the node addresses of the plurality of the nodes of the server cluster.

7. A server cluster comprising several nodes of the server cluster interconnected between each other by at least one data transmission network, of which at least one administration server of the nodes of the cluster includes:
a server memory,
an initialization and administration database, and
means for managing initialization and administration database;
the initialization and administration database comprising initialization and administration data with at least one part of the initialization and administration data generated automatically by computer program instructions contained within the server memory of the server cluster utilizing:
A) a logical distribution of the nodes of the server cluster in the data transmission network,
B) a geographical distribution,
C) a hardware definition of the nodes of the server cluster,
D) an addressing policy of the nodes of the server cluster;
to generate a profile and a node address for a plurality of the several nodes of the server cluster.

8. The server cluster according to claim 7, wherein at least some of the nodes comprises computation nodes and wherein the data transmission network comprises at least one interconnection network of the computation nodes.

9. The server cluster according to claim 8, further comprising at least one traffic management node and at least one data backup node, and wherein the data transmission network further comprises at least one administration network different from the interconnection network of the computation modes for the connection of the administration server to the traffic management nodes and the data backup nodes.
